(19) United States
(12) Patent Application Publication
(10) Pub. No.: US 2026/0027710 A1
(43) Pub. Date: Jan. 29, 2026

(54) INFORMATION PROCESSING APPARATUS, ROBOT SYSTEM, AND INFORMATION PROCESSING METHOD

(71) Applicant: SEIKO EPSON CORPORATION, Tokyo (JP)

(72) Inventors: Kazushige NISHIMORI, AZUMINO-SHI (JP); Shunichi MIZUOCHI, MATSUMOTO-SHI (JP)

(21) Appl. No.: 19/275,834

(22) Filed: Jul. 21, 2025

(30) Foreign Application Priority Data
Jul. 24, 2024 (JP) 2024-118929

(51) Int. Cl. B25J 9/16; B25J 9/04

(52) U.S. Cl. CPC B25J 9/1653; B25J 9/042

(57) ABSTRACT

An information processing apparatus includes a first memory, a determination unit that determines whether a predetermined trigger condition occurs, a writing unit, and a third memory. The writing unit sequentially performs writing of first specific operational information to a second memory and writing of second specific operational information stored in the third memory to the second memory.

### CROSS-REFERENCE TO RELATED APPLICATIONS

The present application is based on, and claims priority from JP Application Serial Number 2024-118929, filed Jul. 24, 2024, the disclosure of which is hereby incorporated by reference herein in its entirety.

### BACKGROUND OF THE INVENTION

### 1. Technical Field

The present disclosure relates to an information processing apparatus, a robot system, and an information processing method.

### 2. Related Art

In recent years, automation of work that has been performed manually has been accelerated by various robots and their peripheral devices due to soaring labor costs and shortage of human resources in factories. In such a robot, it is known to store operational information of the robot using a robot apparatus as described in JP-A-2020-163474. This enables analysis of the operational information of the robot when an error occurs, allowing identification of the cause, degree, and the like of the error.

An information processing apparatus described in JP-A-2020-163474 includes a temporary data recording unit that records operational information pertaining to a fixed time period in real time, a determination unit that determines whether an error has occurred, and a trigger-time data recording unit that extracts and records operational information corresponding to the error from the operational information recorded in the temporary data recording unit when the determination unit determines that the error has occurred. The temporary data recording unit includes a ring buffer, and temporarily records operational information, deletes the operational information after a predetermined time period has elapsed, and records new operational information.

In the information processing apparatus described in JP-A-2020-163474, when a plurality of errors, for example, two errors occur at different times, operational information related to the second error is written to the trigger-time data recording unit after writing of operational information related to the first error to the trigger-time data recording unit is completed.

However, in JP-A-2020-163474, since the temporary data recording unit includes the ring buffer, data is deleted after a fixed time period has elapsed. Therefore, when the second error occurs while the operational information related to the first error is being written to the trigger-time data recording unit, the operational information related to the first error may be deleted before writing of the operational information related to the first error to the trigger-time data recording unit is completed. As described above, in JP-A-2020-163474, when errors frequently occur in a short time, there is a possibility that operational information regarding each error is not appropriately recorded.

### SUMMARY OF THE INVENTION

The information processing apparatus of the present disclosure includes a first memory that stores operational information pertaining to a fixed time period in real time while a robot having a robot arm is operating; a determination unit that determines whether a predetermined trigger condition occurs; a writing unit that, when the determination unit determines that the trigger condition occurs, extracts first specific operational information corresponding to a cause of the trigger condition from the operational information stored in the first memory, and writes the first specific operational information to a second memory; and a third memory that, when the determination unit determines that another trigger condition occurs before the writing unit completes writing of the first specific operational information to the second memory, stores second specific operational information extracted from the operational information by the writing unit, the second specific operational information corresponding to a cause of the other trigger condition. The writing unit sequentially performs writing of the first specific operational information to the second memory and writing of the second specific operational information stored in the third memory to the second memory.

The robot system of the present disclosure includes a robot having a robot arm and an information processing apparatus that processes operational information of the robot. The information processing apparatus includes a first memory that stores operational information pertaining to a fixed time period in real time; a determination unit that determines whether a predetermined trigger condition occurs; a writing unit that, when the determination unit determines that the trigger condition occurs, extracts first specific operational information corresponding to a cause of the trigger condition from the operational information stored in the first memory, and writes the first specific operational information to a second memory; and a third memory that, when the determination unit determines that another trigger condition occurs before the writing unit completes writing of the first specific operational information to the second memory, stores second specific operational information extracted from the operational information by the writing unit, the second specific operational information corresponding to a cause of the other trigger condition. The writing unit sequentially performs writing of the first specific operational information to the second memory and writing of the second specific operational information stored in the third memory to the second memory.

The information processing method of the present disclosure includes a first step of writing operational information pertaining to a fixed time period to a first memory that stores the operational information in real time while a robot having a robot arm is operating; a second step of determining whether a predetermined trigger condition occurs; a third step of, when it is determined in the second step that the trigger condition occurs, writing first specific operational information corresponding to a cause of the trigger condition, of the operational information stored in the first memory, to a second memory; a fourth step of, when another trigger condition occurs before writing of the first specific operational information to the second memory in the third step is completed, extracting second specific operational information corresponding to a cause of the other trigger condition from the operational information and storing the second specific operational information in a third memory; and a fifth step of writing the second specific operational information stored in the third memory to the second memory.

### BRIEF DESCRIPTION OF DRAWINGS

FIG. 1 is a diagram illustrating an overall configuration of a robot system according to an embodiment of the present disclosure.

FIG. 2 is a block diagram of the robot system illustrated in FIG. 1.

FIG. 3 is a functional block diagram of an information processing apparatus included in the robot system illustrated in FIG. 1.

FIG. 4 is a schematic diagram for explaining a state in which operational information is written to a first memory in the information processing apparatus.

FIG. 5 is a schematic diagram for explaining a state in which first specific operational information stored in the first memory is written to a second memory when a trigger condition occurs in the information processing apparatus.

FIG. 6 is a schematic diagram for explaining a state in which second specific operational information stored in the first memory is written to a third memory when a trigger condition occurs in the information processing apparatus.

FIG. 7 is a schematic diagram for explaining a state in which the second specific operational information stored in the third memory is written to the second memory in the information processing apparatus.

FIG. 8 is a flowchart for explaining an example of the information processing apparatus and an information processing method of the present disclosure.

### DETAILED DESCRIPTION OF THE INVENTION

### Embodiment

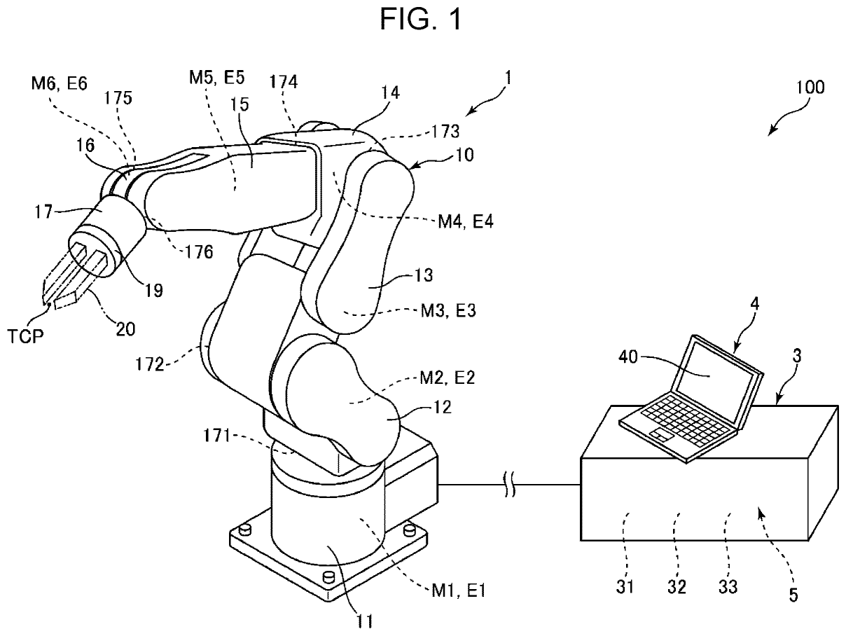

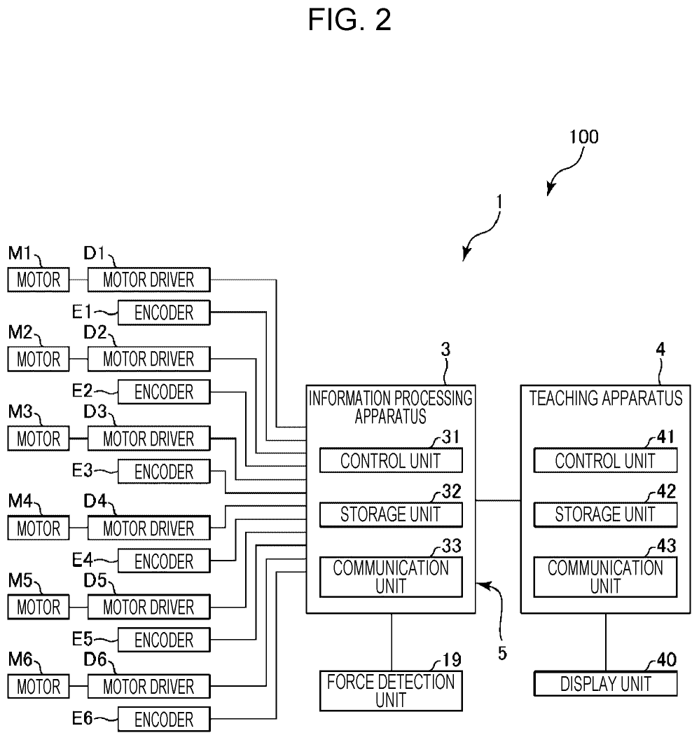

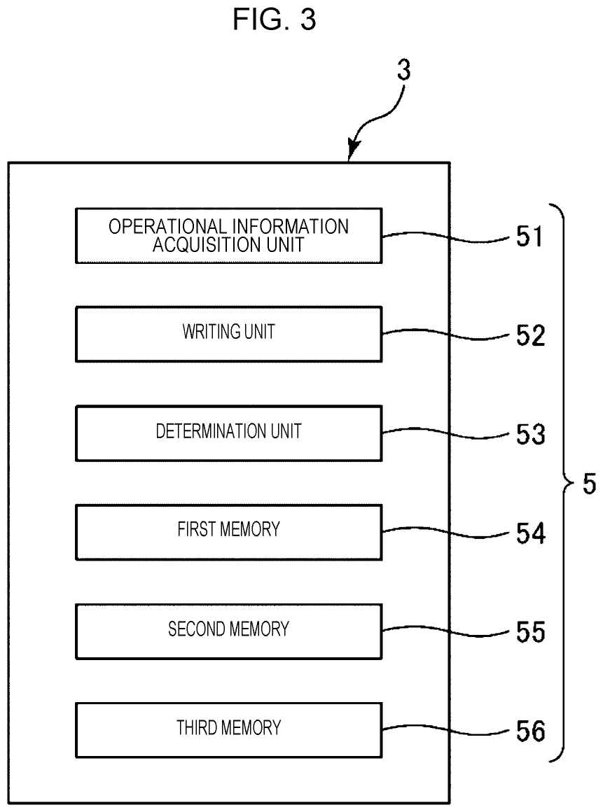

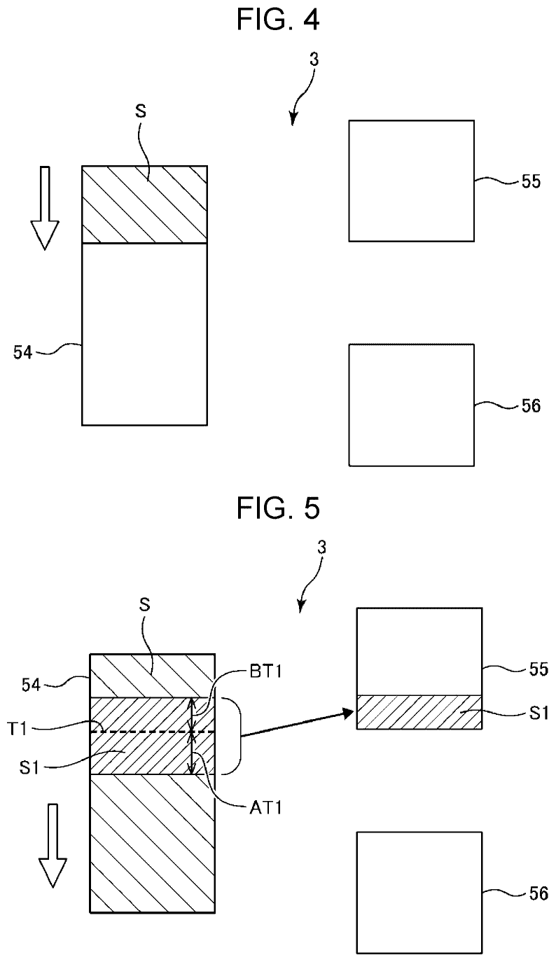

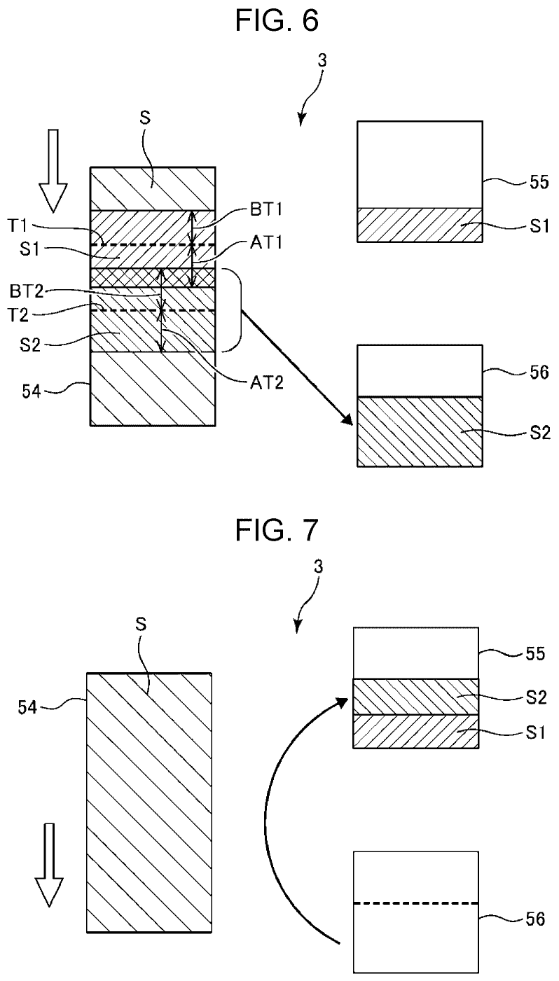

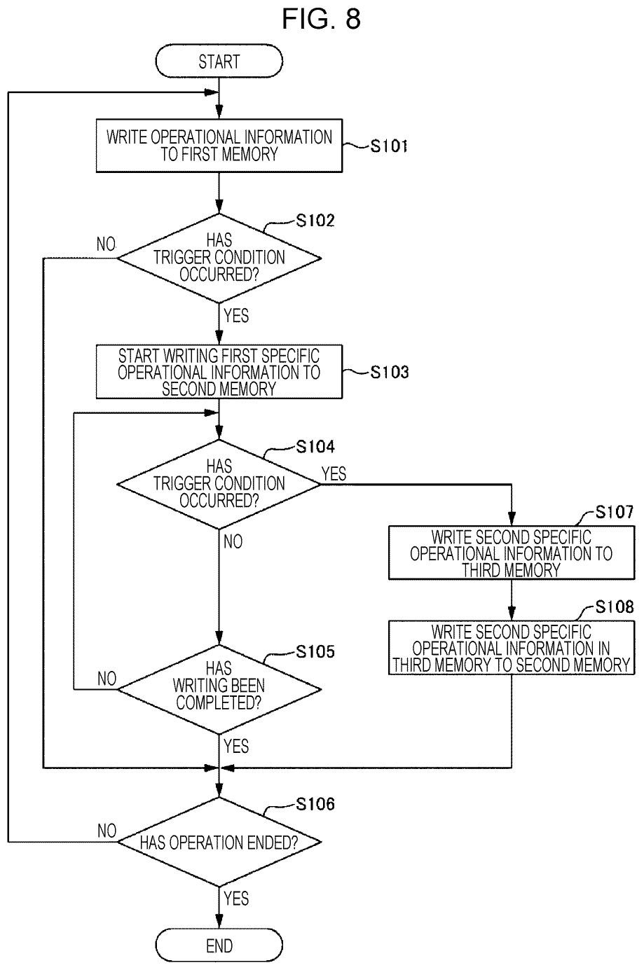

FIG. 1 is a diagram illustrating an overall configuration of a robot system according to an embodiment of the present disclosure. FIG. 2 is a block diagram of the robot system illustrated in FIG. 1. FIG. 3 is a functional block diagram of an information processing apparatus included in the robot system illustrated in FIG. 1. FIG. 4 is a schematic diagram for explaining a state in which operational information is written to a first memory in the information processing apparatus. FIG. 5 is a schematic diagram for explaining a state in which first specific operational information stored in the first memory is written to a second memory when a trigger condition occurs in the information processing apparatus. FIG. 6 is a schematic diagram for explaining a state in which second specific operational information stored in the first memory is written to a third memory when a trigger condition occurs in the information processing apparatus. FIG. 7 is a schematic diagram for explaining a state in which the second specific operational information stored in the third memory is written to the second memory in the information processing apparatus. FIG. 8 is a flowchart for explaining an example of the information processing apparatus and an information processing method of the present disclosure.

Hereinafter, the information processing apparatus, the robot system, and the information processing method of the present disclosure will be described in detail on the basis of preferred embodiments illustrated in the accompanying drawings. For convenience of description, in a robot arm, a base 11 side in FIG. 1 is also hereinafter referred to as a “proximal end”, and the opposite side, that is, an end effector 20 side, is also hereinafter referred to as a “distal end”.

As illustrated in FIG. 1, a robot system 100 includes a robot 1, an information processing apparatus 3 that processes operational information of the robot 1, and a teaching apparatus 4.

First, the robot 1 will be described.

The robot 1 illustrated in FIG. 1 is a single-arm six-axis vertical articulated robot in the present embodiment and includes a base 11 and a robot arm 10. Also, an end effector 20 can be attached to the distal end portion of the robot arm 10. The end effector 20 may be a constituent element of the robot 1 or may not be a constituent element of the robot 1.

Note that the robot 1 is not limited to the illustrated configuration, and may be, for example, a double-arm articulated robot. Furthermore, the robot 1 may be a horizontal articulated robot.

The base 11 is a support body that supports the robot arm 10 from the lower side in FIG. 1 such that the robot arm 10 can be driven, and is fixed to, for example, a floor in a factory. In the robot 1, the base 11 is electrically connected to the information processing apparatus 3 via a relay cable. Note that the connection between the robot 1 and the information processing apparatus 3 is not limited to a wired connection as in the configuration illustrated in FIG. 1, and may be, for example, a wireless connection or a connection via a network such as the Internet.

In the present embodiment, the robot arm 10 includes a first arm 12, a second arm 13, a third arm 14, a fourth arm 15, a fifth arm 16, and a sixth arm 17, and these arms are joined in this order from the base 11 side. Note that the number of arms included in the robot arm 10 is not limited to six, and may be, for example, one, two, three, four, five, or seven or more. Further, the size such as the total length of each arm is not particularly limited, and can be appropriately set.

The base 11 and the first arm 12 are joined via a joint 171. The first arm 12 is rotatable with respect to the base 11 about a first rotation axis that is parallel to the vertical direction. The first rotation axis coincides with a normal line of the floor to which the base 11 is fixed.

The first arm 12 and the second arm 13 are joined via a joint 172. The second arm 13 is rotatable with respect to the first arm 12 about a second rotation axis that is parallel to the horizontal direction. The second rotation axis is parallel to an axis that is orthogonal to the first rotation axis.

The second arm 13 and the third arm 14 are joined via a joint 173. The third arm 14 is rotatable with respect to the second arm 13 about a third rotation axis that is parallel to the horizontal direction. The third rotation axis is parallel to the second rotation axis.

The third arm 14 and the fourth arm 15 are joined via a joint 174. The fourth arm 15 is rotatable with respect to the third arm 14 about a fourth rotation axis that is parallel to the central axial direction of the third arm 14. The fourth rotation axis is orthogonal to the third rotation axis.

The fourth arm 15 and the fifth arm 16 are joined via a joint 175. The fifth arm 16 is rotatable with respect to the fourth arm 15 about a fifth rotation axis. The fifth rotation axis is orthogonal to the fourth rotation axis.

The fifth arm 16 and the sixth arm 17 are joined via a joint 176. The sixth arm 17 is rotatable with respect to the fifth arm 16 about a sixth rotation axis. The sixth rotation axis is orthogonal to the fifth rotation axis.

In addition, the sixth arm 17 is a robot distal end portion positioned at the most distal end side of the robot arm 10. The sixth arm 17 can be rotated together with the end effector 20 by driving the robot arm 10.

The robot 1 includes motors M1, M2, M3, M4, M5, and M6 as drive units, and encoders E1, E2, E3, E4, E5, and E6. The motor M1 is built into the joint 171 and rotates the base 11 and the first arm 12 relative to each other. The motor M2 is built into the joint 172 and rotates the first arm 12 and the second arm 13 relative to each other. The motor M3 is built into the joint 173 and rotates the second arm 13 and the third arm 14 relative to each other. The motor M4 is built into the joint 174 and rotates the third arm 14 and the fourth arm 15 relative to each other. The motor M5 is built into the joint 175 and rotates the fourth arm 15 and the fifth arm 16 relative to each other. The motor M6 is built into the joint 176 and rotates the fifth arm 16 and the sixth arm 17 relative to each other.

In addition, the encoder E1 is built into the joint 171 and detects the position of the motor M1. The encoder E2 is built into the joint 172 and detects the position of the motor M2. The encoder E3 is built into the joint 173 and detects the position of the motor M3. The encoder E4 is built into the joint 174 and detects the position of the motor M4. The encoder E5 is built into the fifth arm 16 and detects the position of the motor M5. The encoder E6 is built into the sixth arm 17 and detects the position of the motor M6.

The encoders E1 to E6 are electrically connected to the information processing apparatus 3, and the position information of the motors M1 to M6, that is, the amount of rotation, is transmitted to the information processing apparatus 3 as an electric signal. On the basis of the position information, the information processing apparatus 3 drives the motors M1 to M6 via motor drivers D1 to D6. That is, controlling the robot arm 10 means controlling the motors M1 to M6.

In addition, in the robot 1, a force detection unit 19 that detects stress applied to the robot arm 10 is installed at the distal end portion of the robot arm 10. The robot arm 10 can be driven in a state where the force detection unit 19 is installed. In the present embodiment, the force detection unit 19 is a six-axis force sensor. That is, the force detection unit 19 is a torque sensor that detects the magnitudes of forces along three detection axes orthogonal to each other and the magnitudes of torques around the three detection axes. The force detection unit 19 is not limited to the six-axis force sensor, and may have another configuration.

The end effector 20 can be detachably attached to the force detection unit 19. In the present embodiment, the end effector 20 includes a hand with a pair of claw portions capable of approaching and separating from each other. The hand grips and releases a work object with the claw portions. Note that the end effector 20 is not limited to the illustrated configuration, and may be a hand that grips a work object by suction. Also, the end effector 20 may be, for example, a polishing machine, a grinding machine, a cutting machine, or a tool such as a screwdriver or a wrench.

Also, in a robot coordinate system, a control point TCP is set at the distal end of the end effector 20. In the robot system 100, the control point TCP can be used as a reference for control by ascertaining the position of the control point TCP in the robot coordinate system.

Next, the teaching apparatus 4 will be described.

As illustrated in FIGS. 1 and 2, the teaching apparatus 4 includes a display unit 40 and has a function of creating an operation program for the robot arm 10 or inputting an operation program to the robot arm 10. The teaching apparatus 4 is not particularly limited, and examples thereof include a tablet, a personal computer, a smartphone, and a teaching pendant.

Specifically, the teaching apparatus 4 includes a control unit 41, a storage unit 42, and a communication unit 43.

The control unit 41 includes, for example, a central processing unit (CPU), and reads various programs such as a teaching program stored in the storage unit 42 and the like.

The communication unit 43 transmits and receives signals to and from the information processing apparatus 3 using an external interface such as a wired local area network (LAN) or a wireless LAN.

Next, the information processing apparatus 3 will be described.

As illustrated in FIGS. 1, 2, and 3, the information processing apparatus 3 has a function of acquiring and storing operational information of the robot 1 and a function of controlling the operation of the robot 1. In this sense, the information processing apparatus 3 can also be referred to as a robot control apparatus having a function of storing robot operational information.

The information processing apparatus 3 may not have the function of controlling the operation of the robot 1. In this case, a robot control apparatus is provided separately from the information processing apparatus 3.

As illustrated in FIG. 1, in the present embodiment, the information processing apparatus 3 is installed at a position away from the robot 1. However, the information processing apparatus 3 is not limited to this configuration, and for example, may be built into the base 11 of the robot 1.

As illustrated in FIG. 2, the information processing apparatus 3 includes a control unit 31, a storage unit 32, and a communication unit 33. These units are communicably connected to each other via, for example, a bus.

The control unit 31 includes, for example, a central processing unit (CPU), and reads and executes various programs such as an operation program stored in the storage unit 32. A signal generated by the control unit 31 is transmitted to each portion of the robot 1 via the communication unit 33. In this way, the robot arm 10 can execute a predetermined operation under predetermined conditions.

The storage unit 32 stores various programs and the like executable by the control unit 31. Examples of the storage unit 32 include a volatile memory such as a random-access memory (RAM), a non-volatile memory such as a read-only memory (ROM), and a detachable external storage device. The storage unit 32 stores a program for executing the information processing method of the present disclosure. However, the program for executing the information processing method of the present disclosure is not limited to this configuration, and may be stored in a storage device other than the storage unit 32, for example, the storage unit 42 of the teaching apparatus 4, a server (not illustrated), or the like.

The communication unit 33 transmits and receives signals to and from the robot 1 using an external interface such as a wired local area network (LAN) or a wireless LAN.

In the robot system 100, the information processing apparatus 3 acquires data constituting operational information regarding the operation of the robot 1 (hereinafter, referred to as “operational information S”) in real time as necessary and stores the acquired operational information S as necessary. The operational information S of the robot 1 includes stress information regarding the stress applied to the robot arm 10 and velocity information regarding the velocity of the robot arm 10.

The stress information regarding the stress applied to the robot arm 10 is obtained on the basis of the detection value of the force detection unit 19. That is, the stress information regarding the stress applied to the robot arm 10, in particular, the stress information regarding the stress applied to the distal end portion (control point TCP) of the robot arm 10, includes the values of forces along three detection axes orthogonal to each other set in the force detection unit 19 and the values of torques around the three detection axes.

The stress information regarding the stress applied to the robot arm 10 is not limited to the above-described configuration, that is, not limited to including the detection value of the force detection unit 19. The stress information regarding the stress applied to the robot arm 10 may be, for example, stress information detected by a force detection unit (not illustrated) similar to the force detection unit 19, installed in the base 11 or each of the joints 171 to 176.

In addition, the stress information regarding the stress applied to the robot arm 10 is not limited to the information obtained by the force detection unit 19 or the like, and may include the detection value of another sensor, for example, a vibration sensor, an inertial sensor, or the like.

The velocity information regarding the velocity of the robot arm 10 is information regarding the velocity of the control point TCP. The velocity of the control point TCP can be obtained from the respective rotational speeds of the joints 171, 172, 173, 174, 175, and 176. The respective rotational speeds of the joints 171, 172, 173, 174, 175, and 176 can be obtained from the detection values of the encoders E1, E2, E3, E4, E5, and E6. That is, the detection values of the encoders E1, E2, E3, E4, E5, and E6 can be regarded as the velocity information regarding the velocity of the robot arm 10.

The velocity information regarding the velocity of the robot arm 10 is not limited to the above-described configuration, and may include velocity information regarding the velocity of a portion other than the control point TCP, for example, a predetermined portion of each arm constituting the robot arm 10.

Further, the velocity information regarding the velocity of the robot arm 10 may be information obtained by calculation from an imaging result of a camera (not illustrated) or may be information obtained by calculation from the detection value of a velocity sensor (not illustrated).

In addition, when the velocity of the control point TCP can be calculated from the detection value of the force detection unit 19, the calculated value may be used as the velocity information regarding the velocity of the robot arm 10 (control point TCP).

The information processing apparatus 3 acquires the above-described operational information S and performs the following processing. This will be described below.

As illustrated in FIG. 3, the information processing apparatus 3 includes, as a functional unit 5, an operational information acquisition unit 51, a writing unit 52, a determination unit 53, a first memory 54, a second memory 55, and a third memory 56. The functional unit 5 can be realized by the hardware configuration example illustrated in FIG. 2.

The operational information acquisition unit 51 acquires operational information S as described above from each portion of the robot 1 in real time while the robot arm 10 is operating.

As illustrated in FIGS. 3, 4, 5, 6, and 7, the writing unit 52 has a function of writing operational information S acquired by the operational information acquisition unit 51 to the first memory 54 (normal write function), a function of writing first specific operational information S1 described later to the second memory 55 (hereinafter referred to as a “first write function”), a function of writing second specific operational information S2 described later to the third memory 56 (hereinafter referred to as a “second write function”), and a function of writing the second specific operational information S2 stored in the third memory 56 to the second memory 55 (hereinafter referred to as a “third write function”). The functions may be performed by one processor or may be performed by a plurality of different processors. When the functions are performed by a plurality of different processors, these processors are collectively referred to as the writing unit 52. Further, each function may use a data transfer method such as direct memory access (DMA).

The writing of information by the writing unit 52 means that the memory to which information has been written stores the information as data in a predetermined format. In addition, the writing of information by the writing unit 52 may be either duplication of data constituting information or deletion and movement of data constituting originally existing information. In the following description, it will be explained as duplication of data constituting information.

The first memory 54 is a storage device provided in the information processing apparatus 3, and includes a volatile memory such as a so-called ring buffer. That is, the first memory 54 stores operational information S pertaining to a fixed time period (hereinafter, described as 30 seconds) in real time, and when a fixed time period has elapsed, overwrites the old operational information S with new operational information S.

In FIG. 4, the first memory 54 is indicated by a rectangle, and the inside of the rectangle is the area for storing information. In the inside of the rectangle, operational information S is written in real time from the upper side toward the lower side in FIG. 4. When the entire area inside the rectangle is, for example, an area for storing operational information S pertaining to 30 seconds, the operational information S is stored from a 0-second mark (the upper end of the rectangle) toward the lower side. After the operational information S pertaining to 30 seconds is stored, the operational information S (old operational information S) is then overwritten sequentially from the operational information S at the 0-second mark (upper end of the rectangle). The writing unit 52 performs the above-described operation in real time during the operation of the robot 1. The above-described write function is the normal write function.

As the operation time of the robot 1 becomes longer, the volume of operational information S of the robot 1 increases enormously. Thus, the above-described configuration in which only the operational information S pertaining to a fixed time period is stored in the first memory 54 is advantageous from the viewpoint of preventing large-sizing of the first memory 54, suppressing memory capacity increase, and reducing costs.

The second memory 55 is a storage device detachably attached to the information processing apparatus 3. The second memory 55 includes, for example, an SD card, a CD-ROM, or a USB memory. A user can detach the second memory 55, in which operational information S is stored, from the information processing apparatus 3, and for example, can reproduce and analyze the operational information S using another device.

In the present embodiment, the second memory 55 is not a constituent element of the information processing apparatus 3, but may be a constituent element thereof.

The third memory 56 is a storage device provided in or connectable to the information processing apparatus 3. The third memory 56 may be a volatile memory or a non-volatile memory. In addition, the third memory 56 may be detachable from the information processing apparatus 3.

The determination unit 53 determines whether a predetermined trigger condition has occurred. The “occurrence of a predetermined trigger condition” means that a condition for the writing unit 52 to perform the first write function or the second write function has been satisfied.

In the present embodiment, each of the fact that the stress applied to the robot arm 10 exceeds a predetermined value (stress threshold value) and the fact that the velocity of the robot arm 10 exceeds a predetermined value (velocity threshold value) is a trigger condition. That is, when at least one of the two conditions that the stress applied to the robot arm 10 exceeds a predetermined value (stress threshold value) or the velocity of the robot arm 10 exceeds a predetermined value (velocity threshold value) is satisfied, the determination unit 53 determines that a predetermined trigger condition has occurred. In this case, the trigger condition occurs in three cases: when the stress applied to the robot arm 10 exceeds the predetermined value, when the velocity of the robot arm 10 exceeds the predetermined value, and when both of them exceed the respective predetermined values.

When the operational information S includes information other than stress information and velocity information, the predetermined trigger condition is appropriately set in accordance with the information other than stress information and velocity information. For example, when the operational information S is information of a captured image of the surroundings of the robot 1 captured by a separately installed camera, the predetermined trigger condition is that an intruding object is confirmed in the captured image of the surroundings of the robot 1. That is, when it is detected that any intruding object approaches the robot 1, a trigger signal is issued, and receiving this signal constitutes the trigger condition.

Furthermore, the predetermined trigger condition may be a condition that the user gives an instruction to perform writing to the second memory 55, in addition to or instead of the above conditions. The user can give an instruction to perform writing using, for example, the teaching apparatus 4 or the like.

Hereinafter, each write function will be described.

### First Write Function

When the determination unit 53 determines that a trigger condition has occurred, the writing unit 52 extracts first specific operational information S1 corresponding to the cause of the trigger condition from the operational information S stored in the first memory 54, and writes the first specific operational information S1 to the second memory 55. For example, when the stress applied to the robot arm 10 exceeds a predetermined value at a time T1, information including stress information, that is, the first specific operational information S1, of the operational information S stored in the first memory 54 is stored in the second memory 55 as illustrated in FIG. 5.

The first specific operational information S1 may be obtained by extracting only information corresponding to the cause of the trigger condition, or may include other information in addition to the information corresponding to the cause of the trigger condition.

In addition, the first specific operational information S1 includes operational information S pertaining to a predetermined time period (preceding time period BT1) before the time T1 at which the trigger condition occurred, and operational information S pertaining to a predetermined time period (subsequent time period AT1) after the time T1 at which the trigger condition occurred. That is, the first specific operational information S1 is operational information S pertaining to several seconds before and after the time T1 at which the trigger condition occurred. Accordingly, it is possible to store, in the second memory 55, the operational information S of the robot 1 before and after the time T1 at which the trigger condition occurred, and ascertain the behavior before and after the time T1 at which the trigger condition occurred.

The number of seconds of each of the preceding time period BT1 and the subsequent time period AT1 is not particularly limited, but the preceding time period BT1 is preferably greater than or equal to 2 seconds but less than or equal to 8 seconds, and the subsequent time period AT1 is preferably greater than or equal to 1 second but less than or equal to 2 seconds.

Furthermore, the ratio between the preceding time period BT1 and the subsequent time period AT1 is not particularly limited, but the ratio AT1/BT1 is preferably greater than or equal to 1 but less than or equal to 4.

At this time, the writing unit 52 subjects the first specific operational information S1 to a compression process (compression encoding process), and writes it to the second memory 55. Thus, the second memory 55 can store a sufficient amount of information.

### Second Write Function

When the determination unit 53 determines that another (new) trigger condition has occurred before the writing unit 52 completes the writing of the first specific operational information S1 to the second memory 55, the writing unit 52 extracts second specific operational information S2 corresponding to the cause of the other trigger condition from the operational information S and stores the second specific operational information S2 in the third memory 56. For example, when the stress applied to the robot arm 10 exceeds a predetermined value (stress threshold value) at a time T2 before the writing unit 52 completes the writing of the first specific operational information S1 to the second memory 55, information including stress information, that is, the second specific operational information S2, of the operational information S stored in the first memory 54 is extracted and stored in the third memory 56 as illustrated in FIG. 6.

The trigger condition for performing the second write function may be the same as or different from the trigger condition for performing the first write function.

The second specific operational information S2 may be obtained by extracting only information corresponding to the cause of the trigger condition, or may include other operational information S in addition to the information corresponding to the cause of the trigger condition.

In addition, the second specific operational information S2 includes operational information S pertaining to a predetermined time period (preceding time period BT2) before the time T2 at which the trigger condition occurred, and operational information S pertaining to a predetermined time period (subsequent time period AT2) after the time T2 at which the trigger condition occurred. That is, the second specific operational information S2 is operational information S pertaining to several seconds before and after the time T2 at which the trigger condition occurred. Accordingly, the operational information S of the robot 1 before and after the time T2 at which the trigger condition occurred can be stored in the third memory 56.

The time periods (BT2 and AT2) before and after the time T2 at which the trigger condition occurred in the second specific operational information S2 are respectively substantially equal to the time periods (BT1 and AT1) before and after the time T1 at which the trigger condition occurred in the first specific operational information S1. A preferred value of the ratio AT2/BT2 is also equal to that of the ratio AT1/BT1 described above.

However, the time periods (BT2 and AT2) before and after the time T2 at which the trigger condition occurred in the second specific operational information S2 are not limited to this configuration, and may be respectively different from the time periods (BT1 and AT1) before and after the time T1 at which the trigger condition occurred in the first specific operational information S1. Also, the ratio AT2/BT2 may be equal to or different from the ratio AT1/BT1.

At this time, the writing unit 52 simply writes the second specific operational information S2 to the third memory 56 without subjecting it to a compression process. The purpose of writing the second specific operational information S2 to the third memory 56 is to prevent the second specific operational information S2 from being overwritten and erased in the first memory 54. Since the compression process is omitted when the second specific operational information S2 is written from the first memory 54 to the third memory 56, data writing can be completed in a short time. That is, it is possible to save the second specific operational information S2 in the third memory 56 in a short time.

### Third Write Function

As illustrated in FIG. 7, the writing unit 52 starts writing the second specific operational information S2 stored in the third memory 56 to the second memory 55, after completing the writing of the first specific operational information S1 to the second memory 55.

At this time, the second specific operational information S2 is subjected to a compression process and written to the second memory 55. Thus, the second memory 55 can store a sufficient amount of information. As described above, when the second specific operational information S2 is written to the third memory 56, the compression process is not performed to complete the writing process in a short time so that the second specific operational information S2 is not overwritten. On the other hand, when the second specific operational information S2 stored in the third memory 56 is written to the second memory 55, the compression process is performed because there is time to spare.

Writing the first specific operational information S1 and the second specific operational information S2 to the second memory 55 takes a relatively long time depending on the volume of data. When the writing of the second specific operational information S2 from the first memory 54 to the second memory 55 is started immediately after a trigger condition occurs during the writing of the first specific operational information S1, there will be a time period during which the first specific operational information S1 and the second specific operational information S2 are written simultaneously. In this case, it takes a long time until the writing of the second specific operational information S2 is completed. In addition, even when the second specific operational information S2 is written from the first memory 54 to the second memory 55 after the writing of the first specific operational information S1 is completed, it takes a long time until the writing of the second specific operational information S2 is completed. In some cases, before writing of the second specific operational information S2 is started, the second specific operational information S2 in the first memory 54 may be overwritten with the next operational information S, so that the second specific operational information S2 cannot be written to the second memory 55.

To address this problem, in the information processing apparatus 3, the writing unit 52 has the first write function, the second write function, and the third write function as described above. That is, when another trigger condition occurs while the first specific operational information S1 is being written to the second memory 55, the writing unit 52 temporarily writes the second specific operational information S2 to the third memory 56, and saves the second specific operational information S2 to prevent it from being overwritten with new operational information S. Then, when the writing of the first specific operational information S1 to the second memory 55 is completed, the writing unit 52 writes the second specific operational information S2 saved in the third memory 56 to the second memory 55. Accordingly, even when trigger conditions frequently occur (occur multiple times) in a short time, it is possible to prevent the second specific operational information S2 from being overwritten and deleted. Therefore, even when trigger conditions frequently occur in a short time, it is possible to accurately store the operational information S corresponding to the cause of each trigger condition in the second memory 55.

In addition, the above-described configuration can shorten the time until the writing of the second specific operational information S2 to the second memory 55 is completed, compared to a configuration in which the first specific operational information S1 and the second specific operational information S2 are sequentially stored in one memory. Therefore, even when trigger conditions frequently occur in a short time, the first specific operational information S1 and the second specific operational information S2 respectively corresponding to the trigger conditions can be quickly stored in the second memory 55. As described above, according to the present disclosure, even when trigger conditions frequently occur in a short time, the first specific operational information S1 and the second specific operational information S2 corresponding to those trigger conditions can be accurately and quickly stored in the second memory 55.

In addition, it is preferable to divide data into pieces when writing or storing the data. That is, it is preferable to divide data for each predetermined time period or for each type of data. This enables quick processing, and ensures smooth restarting in the event of an interruption, a communication error, or the like.

As described above, the information processing apparatus 3 includes the first memory 54 that stores operational information S pertaining to a fixed time period in real time while the robot 1 having the robot arm 10 is operating; the determination unit 53 that determines whether a predetermined trigger condition occurs; the writing unit 52 that, when the determination unit 53 determines that the trigger condition occurs, extracts first specific operational information S1 corresponding to a cause of the trigger condition from the operational information S stored in the first memory 54, and writes the first specific operational information S1 to the second memory 55; and the third memory 56 that, when the determination unit 53 determines that another trigger condition occurs before the writing unit 52 completes writing of the first specific operational information S1 to the second memory 55, stores second specific operational information S2 extracted from the operational information S by the writing unit 52, the second specific operational information S2 corresponding to a cause of the other trigger condition. The writing unit 52 sequentially performs writing of the first specific operational information S1 to the second memory 55 and writing of the second specific operational information S2 stored in the third memory 56 to the second memory 55. As a result, even when trigger conditions frequently occur in a short time, the first specific operational information S1 and the second specific operational information S2 corresponding to those trigger conditions can be accurately and quickly stored in the second memory 55.

Furthermore, the robot system 100 includes the robot 1 having the robot arm 10 and the information processing apparatus 3 that processes operational information S of the robot 1. The information processing apparatus 3 includes the first memory 54 that stores operational information S pertaining to a fixed time period in real time while the robot 1 having the robot arm 10 is operating; the determination unit 53 that determines whether a predetermined trigger condition occurs; the writing unit 52 that, when the determination unit 53 determines that the trigger condition occurs, extracts first specific operational information S1 corresponding to a cause of the trigger condition from the operational information S stored in the first memory 54, and writes the first specific operational information S1 to the second memory 55; and the third memory 56 that, when the determination unit 53 determines that another trigger condition occurs before the writing unit 52 completes writing of the first specific operational information S1 to the second memory 55, stores second specific operational information S2 extracted from the operational information S by the writing unit 52, the second specific operational information S2 corresponding to a cause of the other trigger condition. The writing unit 52 sequentially performs writing of the first specific operational information S1 to the second memory 55 and writing of the second specific operational information S2 stored in the third memory 56 to the second memory 55. As a result, even when trigger conditions frequently occur in a short time, the first specific operational information S1 and the second specific operational information S2 corresponding to those trigger conditions can be accurately and quickly stored in the second memory 55. Therefore, it is possible to, for example, more effectively analyze the behavior of the robot arm 10 before and after the occurrence of a trigger condition, the cause of the trigger condition, and the like, and reflect the analysis in the subsequent appropriate operations of the robot arm 10.

When trigger conditions having different causes occur at the same time, the above-described process can be performed with one of the trigger conditions treated as corresponding to the first specific operational information S1 and the other treated as corresponding to the second specific operational information S2.

When another trigger condition occurs while the second specific operational information S2 is being written to the third memory 56 or the second specific operational information S2 stored in the third memory 56 is being written to the second memory 55, it is preferable to extract third specific operational information corresponding to the cause of the other trigger condition from the operational information S and write it to the third memory 56.

The writing unit 52 starts writing the second specific operational information S2 stored in the third memory 56 to the second memory 55, after completing the writing of the first specific operational information S1 to the second memory 55. Thus, since the writing processes of the first specific operational information S1 and the second specific operational information S2 do not overlap in time, the load on the writing unit 52 can be effectively reduced, and the respective writing processes can be performed more quickly and reliably.

The writing of the second specific operational information S2 stored in the third memory 56 to the second memory 55 may be started before the writing of the first specific operational information S1 to the second memory 55 is completed. That is, the writing of the first specific operational information S1 to the second memory 55 and the writing of the second specific operational information S2 stored in the third memory 56 to the second memory 55 may partially overlap in time.

The operational information S includes at least one of (in the present embodiment, both of) stress information regarding the stress applied to the robot arm 10 and velocity information regarding the velocity of the robot arm 10. This enables accurate storage of highly important stress information and velocity information.

Note that the operational information S may include only one of stress information and velocity information.

Also, the operational information S may include information other than stress information and velocity information, or may include only information other than stress information and velocity information without including any stress information and velocity information. Information other than stress information and velocity information is as described above.

In a case where the operational information S includes stress information, the determination unit 53 determines that a trigger condition has occurred, when the stress exceeds a predetermined value (stress threshold value). In a case where the operational information S includes velocity information, the determination unit 53 determines that a trigger condition has occurred, when the velocity exceeds a predetermined value (velocity threshold value). This allows accurate storage of necessary information.

Each of the first specific operational information S1 and the second specific operational information S2 includes operational information S pertaining to a predetermined time period (preceding time period BT1 or BT2) before the time T1 or T2 at which a trigger condition occurred, and operational information S pertaining to a predetermined time period (subsequent time period AT1 or AT2) after the time T1 or T2 at which the trigger condition occurred. Accordingly, it is possible to store, in the second memory 55, the operational information S of the robot 1 before and after the times T1 and T2 at which the trigger conditions occurred, and ascertain the behavior of the robot arm 10 before and after the times T1 and T2 at which the trigger conditions occurred. In particular, the behavior can be analyzed in more detail and more effectively. The result of the analysis can be reflected in the subsequent appropriate operations of the robot arm 10.

In addition, the writing unit 52 extracts the second specific operational information S2 from the operational information S and writes the second specific operational information S2 to the third memory 56 without compression, and compresses the second specific operational information S2 stored in the third memory 56 and writes the compressed second specific operational information S2 to the second memory 55. Accordingly, even when trigger conditions frequently occur in a short time, it is possible to quickly store the second specific operational information S2 corresponding to the trigger conditions in the third memory 56. Further, the second memory 55 can store a sufficient amount of information.

Each of the first specific operational information S1 and the second specific operational information S2 may include only the operational information S pertaining to a predetermined time period before the time T1 or T2 at which the trigger condition occurred, may include only the operational information S pertaining to a predetermined time period after the time T1 or T2 at which the trigger condition occurred, or may include only the operational information S pertaining to the time T1 or T2 at which the trigger condition occurred.

The robot system 100 may include a notification unit that notifies the occurrence of a trigger condition, the occurrence of a trigger condition and the cause thereof, the execution of writing of the first specific operational information S1 to the second memory 55, the execution of writing of the second specific operational information S2 to the third memory 56, the execution of writing of the second specific operational information S2 from the third memory 56 to the second memory 55, and the like. Examples of the notification unit include the above-described display unit 40, and it is possible to perform notification by displaying each of the above-described notifications on the display unit 40 using characters, graphics, or the like. In addition, although not illustrated, the information processing apparatus 3 may include a display unit similar to the display unit 40, and the display unit may notify each of the above-described notifications.

Next, an example of the information processing apparatus and the information processing method according to the present disclosure will be described with reference to a flowchart illustrated in FIG. 8.

First, in step S101, operational information S pertaining to a fixed time period is stored in the first memory 54 in real time in a state where the robot arm 10 is operating. That is, the operational information acquisition unit 51 acquires the operational information S from the robot 1, and the writing unit 52 writes the acquired operational information S to the first memory 54. Step S101 is the first step.

Next, in step S102, it is determined whether a predetermined trigger condition has occurred. Step S102 is the second step. The determination in this step is performed by the determination unit 53 as described above.

When it is determined in step S102 that a trigger condition has occurred (step S102: YES), the process proceeds to step S103. When it is determined in step S102 that no trigger condition has occurred (step S102: NO), the process proceeds to step S106.

In step S103, writing of first specific operational information S1 to the second memory 55 is started. That is, the writing unit 52 extracts the first specific operational information S1 corresponding to the cause of the trigger condition from the operational information S stored in the first memory 54, and starts writing of the first specific operational information S1 to the second memory 55. Step S103 is the third step.

Next, in step S104, it is determined whether a trigger condition has occurred. That is, it is determined whether another (new) trigger condition has occurred while the first specific operational information S1 is being written to the second memory 55. The determination in this step is performed by the determination unit 53 as described above.

When it is determined in step S104 that a trigger condition has occurred (step S104: YES), the process proceeds to step S107. When it is determined in step S104 that no trigger condition has occurred (step S104: NO), the process proceeds to step S105.

In step S105, it is determined whether writing of the first specific operational information S1 to the second memory 55 has been completed. In step S105, when it is determined that the writing has been completed (step S105: YES), the process proceeds to step S106, and when it is determined that the writing has not been completed (step S105: NO), the process returns to step S104.

On the other hand, when it is determined in step S104 that a trigger condition has occurred, it indicates that another trigger condition has occurred before the writing of the first specific operational information S1 to the second memory 55 is completed. In this case, in step S107, second specific operational information S2 corresponding to the cause of the other trigger condition is extracted from the operational information S in the first memory 54 and stored in the third memory 56. Step S107 is the fourth step. The writing in this step is performed by the writing unit 52 as described above.

Next, when the writing of the first specific operational information S1 to the second memory 55 has been completed, the second specific operational information S2 stored in the third memory 56 is then written to the second memory 55 in step S108. Step S108 is the fifth step. The writing in this step is performed by the writing unit 52 as described above.

Next, in step S106, it is determined whether the operation of the robot 1, that is, the operation of the robot arm 10, has ended. When it is determined in step

S106 that the operation of the robot 1 has ended, the program ends. When it is determined in step S106 that the operation of the robot 1 has not ended, the process returns to step S101.

As described above, the information processing method includes the first step of writing operational information S pertaining to a fixed time period to the first memory 54 that stores the operational information S in real time while the robot 1 having the robot arm 10 is operating; the second step of determining whether a predetermined trigger condition occurs; the third step of, when it is determined in the second step that the trigger condition occurs, writing first specific operational information S1 corresponding to a cause of the trigger condition, of the operational information S stored in the first memory 54, to the second memory 55; the fourth step of, when another trigger condition occurs before writing of the first specific operational information S1 to the second memory 55 in the third step is completed, extracting second specific operational information S2 corresponding to a cause of the other trigger condition from the operational information S and storing the second specific operational information S2 in the third memory 56; and the fifth step of writing the second specific operational information S2 stored in the third memory 56 to the second memory 55. As a result, even when trigger conditions frequently occur in a short time, the first specific operational information S1 and the second specific operational information S2 corresponding to those trigger conditions can be accurately and quickly stored in the second memory 55. Therefore, it is possible to, for example, more effectively analyze the behavior of the robot arm 10 before and after the occurrence of a trigger condition, the cause of the trigger condition, and the like, and reflect the analysis in the subsequent appropriate operations of the robot arm 10.

A program for executing the information processing method of the present disclosure is stored in the storage unit 32 of the information processing apparatus 3. However, the program is not limited to this configuration, and may be stored in the storage unit 42 of the teaching apparatus 4 or may be stored in another storage device.

While the illustrated embodiments of the information processing apparatus, the robot system, and the information processing method of the present disclosure have been described above, the present disclosure is not limited thereto. Furthermore, each unit and each process of the information processing apparatus, the robot system, and the information processing method can be replaced with any structure or process that can exhibit the same function. Additionally, any structure or process may be added.

1. An information processing apparatus comprising:
a first memory that stores operational information pertaining to a fixed time period in real time while a robot having a robot arm is operating;
a determination unit that determines whether a predetermined trigger condition occurs;
a writing unit that, when the determination unit determines that the trigger condition occurs, extracts first specific operational information corresponding to a cause of the trigger condition from the operational information stored in the first memory, and writes the first specific operational information to a second memory; and
a third memory that, when the determination unit determines that another trigger condition occurs before the writing unit completes writing of the first specific operational information to the second memory, stores second specific operational information extracted from the operational information by the writing unit, the second specific operational information corresponding to a cause of the other trigger condition,
wherein the writing unit sequentially performs writing of the first specific operational information to the second memory and writing of the second specific operational information stored in the third memory to the second memory.

2. The information processing apparatus according to claim 1, wherein
the writing unit starts writing of the second specific operational information stored in the third memory to the second memory after completing writing of the first specific operational information to the second memory.

3. The information processing apparatus according to claim 1, wherein
the operational information includes at least one of stress information regarding a stress applied to the robot arm and velocity information regarding a velocity of the robot arm.

4. The information processing apparatus according to claim 3, wherein
in a case where the operational information includes the stress information, the determination unit determines that the trigger condition occurs when the stress exceeds a predetermined value, and
in a case where the operational information includes the velocity information, the determination unit determines that the trigger condition occurs when the velocity exceeds a predetermined value.

5. The information processing apparatus according to claim 1, wherein
the first specific operational information includes operational information pertaining to a predetermined time period before a time at which the trigger condition occurs, and operational information pertaining to a predetermined time period after the time at which the trigger condition occurs, and
the second specific operational information includes operational information pertaining to a predetermined time period before a time at which the other trigger condition occurs, and operational information pertaining to a predetermined time period after the time at which the other trigger condition occurs.

6. The information processing apparatus according to claim 1, wherein
the writing unit extracts the second specific operational information from the operational information and writes the extracted second specific operational information to the third memory without compressing the extracted second specific operational information, and compresses the second specific operational information stored in the third memory and writes the compressed second specific operational information to the second memory.

7. A robot system comprising:
a robot having a robot arm; and
an information processing apparatus that processes operational information of the robot,
the information processing apparatus including:
a first memory that stores operational information pertaining to a fixed time period in real time;
a determination unit that determines whether a predetermined trigger condition occurs;
a writing unit that, when the determination unit determines that the trigger condition occurs, extracts first specific operational information corresponding to a cause of the trigger condition from the operational information stored in the first memory, and writes the first specific operational information to a second memory; and
a third memory that, when the determination unit determines that another trigger condition occurs before the writing unit completes writing of the first specific operational information to the second memory, stores second specific operational information extracted from the operational information by the writing unit, the second specific operational information corresponding to a cause of the other trigger condition,
wherein the writing unit sequentially performs writing of the first specific operational information to the second memory and writing of the second specific operational information stored in the third memory to the second memory.

8. An information processing method comprising:
a first step of writing operational information pertaining to a fixed time period to a first memory that stores the operational information in real time while a robot having a robot arm is operating;
a second step of determining whether a predetermined trigger condition occurs;
a third step of, when it is determined in the second step that the trigger condition occurs, writing first specific operational information corresponding to a cause of the trigger condition, of the operational information stored in the first memory, to a second memory;
a fourth step of, when another trigger condition occurs before writing of the first specific operational information to the second memory in the third step is completed, extracting second specific operational information corresponding to a cause of the other trigger condition from the operational information and storing the second specific operational information in a third memory; and
a fifth step of writing the second specific operational information stored in the third memory to the second memory.
